(19) United States
(12) Patent Application Publication
(10) Pub. No.: US 2013/0342690 A1
(43) Pub. Date: Dec. 26, 2013

(54) Technique for Enhancing the Quality of Compressed Video Images

(71) Applicants: Thomas H. Williams, Longmont, CO (US); Mukta Kar, Louisville, CO (US)

(72) Inventors: Thomas H. Williams, Longmont, CO (US); Mukta Kar, Louisville, CO (US)

(21) Appl. No.: 13/533,865

(22) Filed: Jun. 26, 2012

(51) Int. Cl. H04N 5/225

(52) U.S. Cl. 348/143; 348/370; 348/E05.029

(57) ABSTRACT

The scene is illuminated by light pulses at higher intensities at predetermined times than at times between the predetermined times. Images of the scene are captured at the predetermined times to provide a sequence of anchor frames in a stream of images, and images of the scene are captured at times between said predetermined times to provide non-anchor frames in the stream. The anchor and non-anchor frames are then compressed and processed to produce video with greater compression and reduced noise artifacts.

The scene is illuminated by light pulses with wavelengths outside the visible range. Upon sensing motion, the scene is illuminated by light pulses to provide video in the visible wavelength range.

The scene is illuminated by a sequence of light pulses of different wavelengths when motion is detected in the scene. Different wavelength images of the scene are combined to provide higher resolution colored images without color filtering.

### BACKGROUND OF THE INVENTION

This invention relates in general to optical systems and in particular to systems for improving quality of compressed video images.

For many applications, it is desirable to employ imaging systems to provide high quality compressed images of scenes. Not all imaging applications have the same concerns. For example, in video used for entertainment, all images of a scene in a video stream normally are of the same quality. In security applications, however, most of the pixels in a security camera scene are stationary and of little interest, while information of interest is generally associated with motion. For example, it is desirable to identify from the images from a security camera, whether suspicious activity is occurring or not. When a suspect is detected from the images in a security camera, it will then be desirable to be able to identify the suspect or to determine if such person is carrying a weapon or a soft-drink can. Low quality video is not useful as evidence and allows criminals to escape justice and commit more crimes.

Another problem is the huge quantities of security camera data that are transported onto the Internet, which creates additional burden and cost for network operators such as Multiple System Operators, including cable companies. Increasingly, Cable systems are transporting large amounts of data from security cameras, and it will benefit their operations if bandwidth is not wasted. When good security video is achieved at a lower data rate, cable companies have fewer bits to move. Storage systems also have problems storing all of the data generated by high-definition security cameras. Storing large quantities of video data, typically on Flash memory or hard drives, is costly.

Another problem is that infrared light emitting diodes (LEDs) are frequently used to illuminate a security camera's field of view at night, but the pictures at a distance are typically grainy. When more steady current is passed through the LED to produce more light, the life of the LED is greatly reduced.

It is therefore desirable to provide a technique for improving quality of compressed images where the above identified problems are alleviated.

### SUMMARY OF THE INVENTION

In one embodiment of the invention, the scene is illuminated by light pulses at first predetermined times such that the scene is illuminated at higher intensities at the first predetermined times than at least some of times between the first predetermined times. Images of the scene are captured at the first predetermined times to provide a sequence of anchor frames in a stream of images, and images of the scene are captured at times between said first predetermined times to provide non-anchor frames in the stream. The anchor and non-anchor frames are then compressed and stored or transmitted. The light pulses may be provided by a light source. The capturing may be performed by an imaging device, such as a camera.

To reconstruct the images from an imaging system, the anchor and non-anchor frames are processed to produce video from files or from a data stream with greater compression and reduced noise artifacts. The processing for reconstruction of the anchor and non-anchor frames may be performed by a processor.

In another embodiment of the invention, the scene is illuminated by a sequence of light pulses with wavelengths outside the visible range, such as infrared. Light from the illuminated scene is sensed to provide a stream of images of the scene, which images are captured and processed for motion detection in the scene. The scene is illuminated by a sequence of light pulses in a visible wavelength range when motion is detected in the scene. Sensing light from the scene in the visible wavelength will provide color video of objects in motion in the scene.

In yet another embodiment of the invention, the scene is illuminated by a sequence of light pulses. Light from the illuminated scene is sensed by means of light sensors such as charged coupled device (CCD) or other types of sensors (such as complementary metal-oxide-semiconductor or CMOS sensors) sensitive to a range of wavelengths to provide a stream of images of the scene. The images in the stream are captured and detected for motion in the scene. The scene is illuminated by a sequence of light pulses of different wavelengths within said range of wavelengths when motion is detected in the scene. Light from the illuminated scene of the different wavelengths within said range of wavelengths is sensed by means of the sensors. Images of the scene illuminated by light pulses of the different wavelengths are captured and combined to provide colored images without color filtering over pixels on the light sensors.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIG. 1 is a block diagram of an imaging system to illustrate an embodiment of the invention.

FIG. 2 is a graphical plot of groups of pictures (GOPs) and corresponding light pulses, provided sequentially over time to illustrate embodiments of the invention.

### DETAILED DESCRIPTION OF EXEMPLARY EMBODIMENTS

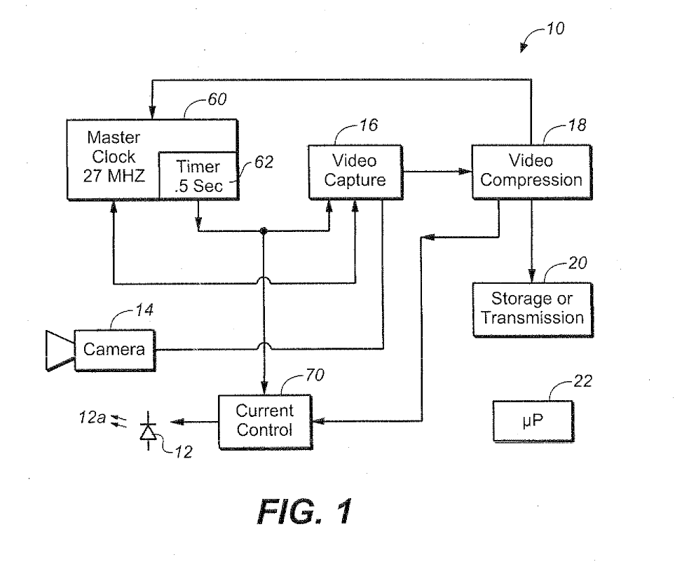

FIG. 1 is a block diagram of an imaging system 10 to illustrate an embodiment of the invention. A light source 12, comprising for example one or more light emitting diodes (LEDs), (even though only one LED shown in FIG. 1), generates light along arrows 12a to illuminate a scene (not shown). Light from the scene is sensed by a camera 14, which provides images of the scene to an imaging capture device such as video capture block 16. Camera 14 may be any conventional type, such as one employing CCD or CMOS devices that accumulate electrical charges in response to light. Video capture block 16 converts analog or digital signals from the camera 12 into a digital stream which is supplied to video compression block 18 where the digitized images are compressed using a conventional technique, such as one according to one of the MPEG standards. The compressed images are then transmitted to a communication network such as a cable network or the internet 20 or are stored in a storage medium 20.

The blocks 16, 18 and 20 of FIG. 1 are functional blocks. The functions in blocks 16, 18 and 20 may be implemented in a number of different ways, such as in hardware, or in software controlled and executed by microprocessor 22 employing memories (not shown) such as random access memories (RAMs) and read only memories (ROMs). To simplify the diagram in FIG. 1, the connections between the microprocessor 22 and the functional blocks are not shown. The microprocessor 22 and the functional blocks may be implemented in a number of ways, such as in an integrated circuit chip in the camera 14. Such and other implementations are within the scope of the invention.

As noted above, one of the problems encountered in prior security camera systems is that the images are frequently grainy and not clear enough to be able to identify the suspect or to determine if such person is carrying a weapon or a soft-drink can, so that the images are not useful for identification of the suspect or as evidence for proving that a crime has been committed. Images of the scene from camera 14 are supplied to video capture 16 and video compression 18 for processing, to produce video frames. To overcome the shortcomings of the prior security camera systems, in one embodiment of the invention, the scene is illuminated at first predetermined times by light pulses from the LED or LEDs 12 when images from camera 14 are captured by video capture 16 and compressed by video compression 18 to provide anchor video frames. An anchor frame, in one embodiment, is one that does not require additional information for reconstructing the corresponding image of the scene. When video compression in block 18 is performed according to one of the MPEG standards, anchor frames may be intra-coded picture frames (I-frames).

In addition to capturing anchor frames, video capture 16 and video compression 18 also process images obtained by camera 14 at times between the first predetermined times to provide non-anchor frames. Where video compression in block 18 is performed according to one of the MPEG standards, non-anchor frames may be predicted picture frames (P-frames) and bi-predicted picture frames (B-frames). While the embodiments herein are described using I, B, P frames under the MPEG standards, they can be implemented using other video compression standards (such as H.261 used in video telephony) as well. In some embodiments, non-anchor frames may include only P-frames but no B-frames. Such and other implementations are within the scope of the invention. The anchor and non-anchor frames are then either stored in storage medium 20 or transmitted through communication network 20.

In play back mode, microprocessor 22 or another processor in a play back system (not shown) processes the stored or transmitted anchor and non-anchor frames to produce video that was stored or transmitted with greater compression and reduced noise artifacts compared to conventional video compression systems. Since the anchor frames are the ones captured from images obtained from the scene illuminated by the pulses from LED 12, these images have high brightness and higher signal to noise ratio so that when the anchor frames are processed with the non-anchor frames, reduced noise video is produced, with greater compression and reduced noise artifacts. If a frame has low signal-to-noise ratio, higher degree of compression of the frame will result in poor quality video during play back. This means that a frame with low signal-to-noise ratio either cannot be compressed or can only be compressed slightly and the compressed frame will still require a relatively large number of bits for storage or transmission, resulting in low compression efficiency. In contrast, the anchor frames that have a high signal to noise ratio may be compressed to fewer bits than frames with low signal-to-noise ratio (i.e. greater compression and high compression efficiency) for storage or transmission. The use of light pulses from LED 12 illuminating the scene when anchor frames are captured enables a higher signal to noise and a greater compression of the anchor frames, and reduces the storage capacity of storage devices required for storing such frames and the bandwidth required for transmitting such frames.

Since the anchor frames are ones that do not require additional information for reconstructing corresponding images of the scene, these frames can form the basis for reconstructing corresponding high definition and resolution video of the scene, even though the non-anchor frames that are combined with the anchor frames may be grainy. Non-anchor frames typically require fewer bits so that the amount of storage or bandwidth for storing or transmitting the anchor and non-anchor frames is reduced. By providing light pulses to illuminate the scene only for the capturing anchor frames, the light source such as LEDs do not need to be subjected to high current except during the capturing of the anchor frames. This reduces the total amount of current over time through the LEDs and prolongs their useful life.

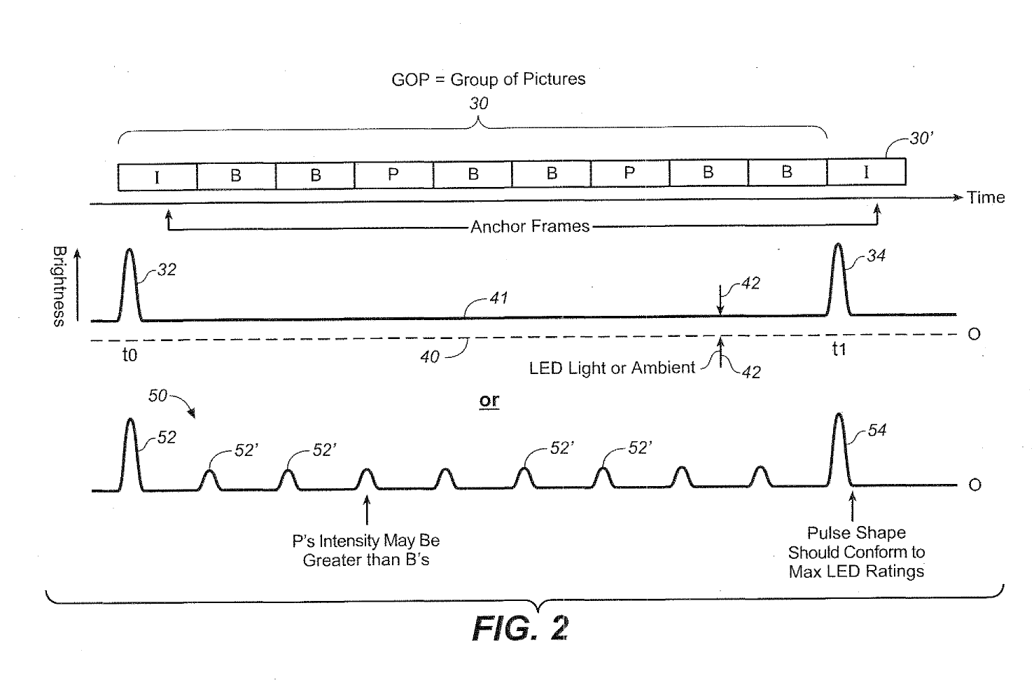

To illustrate the above features, FIG. 2 shows a stream of a group 30 of frames (also referred to herein as group of pictures or GOP 30) comprising I-, B- and P-frames at the output of video compression 18 to illustrate one embodiment of the invention. The GOP 30 includes the following frames: I, B, B, P, B, B, P, B, B. This frame pattern in GOP 30 is then repeated indefinitely in subsequent GOPs in the stream of frames, where only the first frame (I) of the next GOP 30′ in the stream of frames is shown in FIG. 2. LED 12 provides a light pulse 32 only at time t0 during the GOP 30 and provides the next light pulse 34 only at time t1 during the next GOP 30′. Thus LED 12 will provide a light pulse only when an image of the scene is taken by the camera from which an I-frame in a GOP is captured. This is true for GOPs 30 and 30′ and subsequent GOPs in the stream of frames. Thus, for each of the GOPs in the stream, LED 12 provides a single light pulse, where the single 1-frame in such GOP is obtained by video compression 18 by processing the corresponding image of the scene illuminated by such light pulse. The remaining frames B, B, P, B, B, P, B, B in GOP 30 may be obtained in a manner known to those skilled in the art by video compression 18 from the image of the scene from which the I-frame in GOP 30 is obtained and images subsequent or prior to such image from camera 14. GOP 30 and subsequent GOPs from video compression 18 may then be stored in medium 20 or transmitted through medium 20, under the control of microprocessor 22. The images corresponding to the GOPs can be reconstructed in a manner known to those skilled in the art. While the above example of GOPs 30 and 30′ each includes nine frames, it will be understood that the number of frames in the GOPs need not be constant but may vary. As noted below, an arbitrary number of extra I-frames may be added to selected GOPs which will cause the GOPs in the stream of frames to contain different number of frames.

The above features enable better quality video of the scene to be obtained and reconstructed, while requiring the LED 12 to provide light pulses only at the predetermined times when the images for deriving corresponding I-frames in the GOPs are obtained by camera 14. Thus, there is no need for the LED 12 to provide pulses at other times when other frames in the GOPs are acquired, assuming there is some background lighting. This reduces the current that is passed through the LED 12 to produce light, and increases the useful life of the LED.

The above features also improve quality of the reconstructed images without increasing the storage load or bandwidth requirement for transmission. The improvement is achieved by obtaining better quality images with better signal-to-noise ratio which allows greater and more-efficient compression. This results in fewer bits of information to be stored or transmitted.

Dotted line 40 in FIG. 2 is the reference level indicating a totally dark environment when the scene is not illuminated by any light at all. When images are obtained by camera 14 corresponding to the non-anchor frames such as P- and B-frames, the scene may also be illuminated by ambient light from the environment at a brightness illustrated by line 41 in FIG. 2. The gap between the arrows 42 indicates the intensity or brightness of the ambient light. The terms “intensity” and “brightness” are used interchangeably herein. Alternatively, when images are obtained by camera 14 corresponding to the non-anchor frames such as P- and B-frames, the scene may also be illuminated by light of constant low brightness from LED 12, where solid line 41 in FIG. 2, in this case, illustrates the total intensity of light from LED 12 and of any ambient light that may be present. When it is desirable to obtain an image for deriving an anchor frame such as an I-frame, pulses such as pulses 32 and 34 are then provided by LED 12 to illuminate the scene.

Where the LED 12 provides only light of constant low brightness for images from which the non-anchor frames are derived, only low or moderate current is applied to the LED 12, which will not materially affect its useful life.

As yet another alternative, LED 12 may provide light pulses of different brightness to illuminate the scene for generating the anchor frames and non-anchor frames. This is illustrated by the pulses in the plot 50 in FIG. 2. For generating anchor frames such as I-frames, the scene is illuminated by pulses 52 and 54 of higher brightness. For generating the non-anchor frames such as B- and P-frames, the scene is illuminated by pulses 52′ of lower brightness. In a variation of this embodiment, the pulses for generating P-frames may be higher in brightness than the pulses for generating B-frames. This solution would work in conditions of no ambient light, which is total darkness.

To synchronize the generation of light pulses from LED 12 and the capturing of images obtained by camera 14 for generating the anchor and non-anchor frames, a timer 62 of a master clock 60 may be used. Master clock 60 may operate at a frequency such as 27 MHz. Under the control of the master clock 60, timer 62 generates timing pulses that are supplied to video capture 16 to trigger video capture 16 into capturing the images from camera 14. The captured images are sent to video compression 18 for generating the anchor and non-anchor frames. The illuminated frames are passed by block 16 to block 18.

In response to each timing pulse from timer 62, current control 70 supplies current to LED 12 to cause the LED to emit light. In some embodiments described below, current control 70 may supply a substantially constant current to LED 12 to cause the LED to emit light of constant low brightness to illuminate the scene even when no timing pulse from timer 62 is received. Such operations of the current control 70 may be controlled by microprocessor 22.

In the embodiment where LED 12 provides light pulses only when images of the scene are obtained for deriving the anchor frames in the GOPs, the timing pulses from timer 62 are sent to current control 70 for controlling current supplied to LED 12 only for the generation of light pulses such as 32 and 34 and similar light pulses subsequent to 32 and 34 (not shown) for GOPs subsequent to GOPs 30 and 30′, in order for the anchor frames in the GOPs to be generated. Thus, the timing pulses define the predetermined times when the scene is illuminated by light pulses from LED 12. The timing pulses from timer 62 are also sent to video capture 16, which will preferably tag the images received by video capture 16 from camera 14 at times when the timing pulses are received by video capture 16. Such tags are read by video compression 18 for deriving the anchor frames from the images that are tagged. The images from camera 14 that are not so tagged by video capture 16 will be treated differently by video compression 18 and are used for generating non-anchor frames. At times where no timing pulses are received by current control 70, LED 12 may simply not generate any light so that the scene is illuminated only by ambient light, or may generate light of constant low brightness to illuminate the scene.

Alternatively, LED 12 may generate light pulses in response to each of the timing pulses from timer 62 sent to current control 70; each of the timing pulses will also cause video capture 16 to capture an image from camera 14 upon receiving the timing pulse. However, for each one of a given number n of timing pulses (n being a positive integer) received by current control 70 from timer 62, current control 70 in FIG. 1 will supply a higher current to the LED 12 to cause it to generate a light pulse of higher brightness (e.g. pulses 52, 54) than light pulses (e.g. pulses 52′) from LED 12 when other timing pulses are received. In the example in FIG. 2, for example, where each of the GOPs includes a total of 9 frames, so that n is equal to 9, only one is an I-frame. In this example, current control 70 will supply a higher current to the LED 12 only in response to one in nine timing pulses. Video capture 16 captures an image received from camera 14 when each of the timing pulses from timer 62 is received. For each one of a given number n of timing pulses received by video capture 16, video capture 16 tags the image received from camera 14 as an image from which an anchor frame is to be derived. Current control 70 and video capture 16 are synchronized so that the same timing pulse that triggers current control 70 to supply the higher current to LED 12 will also cause video capture 16 to tag the image received from camera 14 as an image from which an anchor frame is to be derived. For example, timer 62 may send programming to a programmable counter (not shown) that controls both the current control 70 and video capture 16. The counter sends an output signal once for every n (e.g. 9 in the embodiment of FIG. 2) timing pulses received by the counter, to current control 70 and video capture 16. This signal causes current control 70 to supply a higher current to the LED 12 and causes video capture 16 to tag the image received once every n timing pulses.

To increase the brightness of the light pulse for the generation of P-frames compared to the brightness of the light pulse for the generation of B-frames, timer 62 may supply other timing pulses that are different from those for causing the generation of pulses 52 and 54. This can be done under microprocessor control or can be accomplished by the simple programmable counter.

In the case of a bank robbery a teller could hit a button that caused the system to make better images. In this case, as an alternative embodiment, the microprocessor 22 would execute a subroutine that increases the current supplied to LED 12 to increase the brightness of light pulses emitted by the LED for the generation of anchor frames at higher brightness. This can be done by microprocessor 22 controlling the master clock 60 and timer 62. In general the microprocessor should have the job of keeping the LEDs from wearing out too soon. For example if the camera was located in a mall, the motion detector would wear out the LEDs, but would function as-intended if the scene was a closed store or an alley.

As noted above, when motion of objects or bodies in the scene is detected by a security camera, it is desirable for the images and the video obtained to have better quality and higher signal-to-noise ratio. For this purpose it will be desirable to increase the frequency or brightness or both of the light pulses from LED for illuminating the scene. Thus, when video compression 18 detects motion of objects or bodies in the scene during the compression process where motion vectors are derived, video compression 18 may send signals to the current control 70 to increase current supplied to the LED 12 in order to increase the pulse intensity. When video compression 18 detects motion during the compression process, video compression 18 may send signals to the master clock 60 causing the timer 62 to increase the frequency of the timing signals sent to current control 70 and to video capture 16, to increase the frequency of higher brightness light pulses and the frequency at which anchor frames are obtained (by increasing the frequency of image tagging), thereby increasing the proportion of anchor frames relative to non-anchor frames in the GOPs. For example, instead of only one I-frame in a group of nine frames as shown in GOP 30 in FIG. 2, one may wish to have one I-frame in each group of seven or five frames in the GOP. In certain embodiments, an arbitrary and changing number of extra I-frames may be captured in selected ones or all of the GOPs such as GOP 30 and 30′ when it is important to capture moving objects or bodies in the scene, under the control of the microprocessor 22. In some embodiments, it may be desirable to increase both the brightness of the LED light pulses and the frequency at which anchor frames are obtained, which is allowed by the MPEG standard.

Where the anchor frames are obtained at higher brightness than non-anchor frames, video capture or video compression under the control of microprocessor 22 may normalize the images prior to when they are processed for digitization or compression and before the frames obtained from such images are stored or transmitted. This normalization results in noise reduction without brightness increase.

Infrared LEDs are frequently used to illuminate a security camera's field of view at night, but the pictures do not provide color images and may be grainy (noisy). To allow easier identification and detection of suspicious activity, it may be desirable to employ additional LEDs for generating light in the human visible range, and to illuminate the scene with human-visible light from such LEDs when video compression 18 detects motion of objects or bodies in the scene during the compression process where motion vectors are derived from infrared images. Camera 14 is preferably one that can sense both infrared light and human visible light, so that no extra camera is necessary. Alternatively, an additional camera may be deployed for recording images visible to humans. Preferably the human visible light includes light of different wavelengths, such as two or more of the following: red, blue, green. Images obtained at such wavelengths may be combined to form full color images. By illuminating the scene with human visible light, color video of objects in motion can be obtained.

In many present cameras using CCDs, the CCDs employ pixels that are sensitive to light of different wavelengths. One popular pixel arrangement is where 4 pixels form a pixel imaging unit, where two of the pixels are sensitive to green light, one pixel sensitive to blue light and the remaining pixel sensitive to red light. Hence, to form a full color image, the combination of all four pixels must be used to display a full color image over the four pixel area. Since the pixel size is small, the human eye will see a spatial average of the light from the four pixels. However, this means that the resolution of the CCDs will only be the total number of pixels divided by four. Color filtering is typically employed over the sensor pixels to enable full color video to be obtained.

Another embodiment is based on the recognition that resolution can be increased relative to the above conventional scheme by illuminating the scene with a time sequence of different color light, such as red, green and blue light. The different color images may then be combined into a full color image provided that there is little motion occurring between the sequential images of different color. In this manner, resolution can be increased since each pixel of the image defines the resolution, instead of four pixels defining the resolution in the above example.

According to another embodiment, LEDs 12 emitting light of different wavelengths within a range of wavelengths are used and the camera 14 employs charged coupled device (CCD) or CMOS sensors which are sensitive to light within the range of wavelengths. The scene is illuminated by light from one or more of the LEDs 12. The images from camera 14 from the scene are captured by video capture 16 and compressed by video compression 18. When video compression 18 detects motion of objects or bodies in the scene during the compression process where motion vectors are derived, video compression 18 may send signals to the current control 70 to cause different ones of the LEDs 12 to emit light at different times, so as to emit as a unit, a sequence of light pulses of different wavelengths to illuminate the scene under the control of microprocessor 22 in a subroutine. Light from the illuminated scene of the different wavelengths within said range of wavelengths is sensed by means of the CCD or CMOS sensors in the camera. Images of the scene illuminated by light pulses of the different wavelengths are captured and combined to produce color images with increased imaging resolution and without color filtering over the sensor pixels. Provided the sequential images of different color occur in quick succession (or there is little motion occurring between the sequential images), these images may be combined in video capture 16 or video compression 18 under the control of microprocessor 22 to produce higher resolution color images. Such color images may be obtained without filtering out of color components, unlike many conventional schemes.

In addition to the human visible wavelengths such as red, blue, green, it may also be desirable to include ultraviolet and infrared light in the range of wavelengths of the sequence of light pulses. Thus light pulses of different wavelengths in the sequence above may include two or more of the following: red, blue, green, ultraviolet and infrared light.

Thus, anchor frames may be illuminated by pulses of light from a LED 12. The pulses of light may be of uniform peak brightness or have an increased peak brightness in response to motion detected by video compression block 18. The non-anchor frames may be illuminated by ambient light, uniform LED lighting, or pulsed LED lighting, or a combination of LED and ambient lightning. If pulsed LED lighting is employed P and B frames may utilize different peak brightness levels relative to I frames and relative to each other.

The anchor frames, which may be I frames, may be controlled by timer 62. Timer 62 can produce more-frequent I frames in response to motion detected by video compression block 18. Thus, both the frequency of pulses 32 and 34 can be increased as well as the peak brightness of 32 and 34.

Another benefit of illuminating a dark scene with pulsed light is less smearing or blurriness relative to illuminating a dark scene with steady light.

Although the various aspects of the present invention have been described with respect to certain preferred embodiments, it is understood that the invention is entitled to protection within the full scope of the appended claims. For example, while the embodiments are illustrated by transmission of television programs, the techniques illustrated thereby are equally applicable to the transmission of such as movies and songs or still other types of audio programs, video programs or audiovisual programs.

What is claimed is:

1. A method for enhancing quality of compressed images of a scene that changes over time, comprising:
illuminating the scene by light pulses at first predetermined times such that the scene is illuminated at higher intensities at said first predetermined times than at at least some of times between said first predetermined times;
capturing images of the scene at said first predetermined times to provide a sequence of anchor frames in a stream of images and images of the scene at times between said first predetermined times to provide non-anchor frames in the stream; and
storing or transmitting the anchor and non-anchor frames.

2. The method of claim 1, wherein said non-anchor frames require additional information for reconstructing corresponding images of the scene, and anchor frames do not require additional information for reconstructing corresponding images of the scene.

3. The method of claim 1, wherein when the images are captured to provide the non-anchor frames no light pulses are provided and the scene is illuminated only by ambient light.

4. The method of claim 1, further comprising illuminating the scene, at second predetermined times between said first predetermined times, by light pulses at intensities lower than the intensities of light pulses illuminating the scene at said first predetermined times, wherein said capturing captures images of the scene at the second predetermined times to provide the non-anchor frames.

5. The method of claim 1, wherein said anchor frames include intra-coded picture frames (I-frames), and said non-anchor frames include predicted picture frames (P-frames) and bi-predicted picture frames (B-frames).

6. The method of claim 1, further comprising detecting motion of objects or bodies in the scene, and increasing a frequency and/or brightness at which the scene is illuminated at said higher intensities and at which images are captured at said higher intensities for providing anchor frames when motion of objects or bodies in the scene is detected.

7. The method of claim 1, wherein said illuminating is performed by means of a light source that generates said light pulses, and said capturing is performed by an imaging device, said method further comprising generating a sequence of timing signals supplied to said light source to cause said light source to generate said light pulses at first predetermined times, and supplied to said imaging device to cause the imaging device to capture said images of the scene at said first predetermined times.

8. The method of claim 7, further comprising detecting motion of objects or bodies in the scene, and increasing a frequency of said sequence of timing signals supplied to said light source and said imaging device when motion of objects or bodies in the scene is detected.

9. The method of claim 7, further comprising tagging the images in the stream captured by said imaging device in response to timing signals in the sequence of timing signals as anchor frames, wherein the images in the stream that are not tagged are non-anchor frames.

10. The method of claim 7, wherein said light source generates light pulses to illuminate the scene at said first predetermined times and at times between said first predetermined times, wherein intensities of the light pulses generated by the light source at said first predetermined times in response to the sequence of timing signals are higher than intensities of the light pulses generated by the light source at times between said first predetermined times.

11. The method of claim 1, wherein intensities of the anchor frames and non-anchor frames in the stream are normalized to account for different intensities at which the scene is illuminated.

12. The method of claim 1, further comprising processing said anchor and non-anchor frames to produce video.

13. An apparatus for enhancing the quality of compressed images of a scene that changes over time, comprising:
a light source providing light pulses to illuminate the scene at first predetermined times such that the scene is illuminated at higher intensities at said first predetermined times than at least some of times between said first predetermined times;
an imaging device capturing images of the scene at said first predetermined times to provide a sequence of anchor frames in a stream of images and images of the scene at times between said first predetermined times to provide non-anchor frames in the stream; and
an element storing or transmitting the anchor and non-anchor frames.

14. The apparatus of claim 13, wherein said non-anchor frames require additional information for reconstructing corresponding images of the scene, and anchor frames do not require additional information for reconstructing corresponding images of the scene.

15. The apparatus of claim 13, wherein when the images are captured to provide the non-anchor frames no light pulses are provided by the light source and the scene is illuminated only by ambient light.

16. The apparatus of claim 13, wherein the light source illuminates the scene, at second predetermined times between said first predetermined times, by providing light pulses at intensities lower than the intensities of light pulses provided to illuminate the scene at first predetermined times, wherein said imaging device captures images of the scene at the second predetermined times to provide the non-anchor frames.

17. The apparatus of claim 13, wherein said anchor frames include intra-coded picture frames (I-frames), and said non-anchor frames include predicted picture frames (P-frames) and bi-predicted picture frames (B-frames).

18. The apparatus of claim 13, further comprising means for detecting motion of objects or bodies in the scene, and for increasing the frequency at which the scene is illuminated at said higher intensities and at which images are captured at said higher intensities for providing anchor frames when motion of objects or bodies in the scene is detected.

19. The apparatus of claim 13, further comprising a timer generating a sequence of timing signals supplied to said light source to cause said light source to generate said light pulses at first predetermined times, and supplied to said imaging device to cause the imaging device to capture said images of the scene at said first predetermined times.

20. The apparatus of claim 19, further comprising means for detecting motion of objects or bodies in the scene, and for increasing a frequency of said sequence of timing signals supplied to said light source and said imaging device when motion of objects or bodies in the scene is detected.

21. The apparatus of claim 19, further comprising means for tagging the images in the stream captured by said imaging device in response to timing signals in the sequence of timing signals as anchor frames, wherein the images in the stream that are not tagged are non-anchor frames.

22. The apparatus of claim 13, wherein said light source generates light pulses to illuminate the scene at said first predetermined times and at times between said first predetermined times, wherein intensities of the light pulses generated by the light source at said first predetermined times is higher than intensities of the light pulses generated by the light source at times between said first predetermined times.

23. The apparatus of claim 13, wherein intensities of the anchor frames and non-anchor frames in the stream are normalized to account for different intensities at which the scene is illuminated.

24. The apparatus of claim 13, further comprising a processor processing said anchor and non-anchor frames to produce video.

25. A method for enhancing quality of compressed images of a scene that changes over time, comprising:
illuminating the scene by a sequence of light pulses with wavelengths outside a human's visible wavelength range;
sensing light from the illuminated scene to provide a stream of images of the scene;
capturing the images in the stream and detecting motion in the scene from the captured images;
illuminating the scene by a sequence of light pulses in a human's visible wavelength range when motion is detected in the scene; and
sensing light from the scene illuminated by the light pulses in the human's visible wavelength range to provide a stream of images of the scene in the human's visible wavelength range

26. The method of claim 25, wherein the sequence of light pulses in the human's visible wavelength range includes light pulses of different wavelengths, said method further comprising capturing and combining images of the scene illuminated by light pulses of different wavelengths to produce color images.

27. The method of claim 26, wherein the different wavelength light include two or more of the following: red, blue, green, ultraviolet and infrared light.

28. A method for enhancing quality of compressed images of a scene that changes over time, comprising:
illuminating the scene by a sequence of light pulses;
sensing light from the illuminated scene by means of CCD or CMOS sensors sensitive to a range of wavelengths to provide a stream of images of the scene;
capturing the images in the stream and detecting motion in the scene from the captured images;
illuminating the scene by a sequence of light pulses of different wavelengths within said range of wavelengths when motion is detected in the scene;
sensing light from the illuminated scene of the different wavelengths within said range of wavelengths by means of the CCD or CMOS sensors;
capturing and combining images of the scene illuminated by light pulses of the different wavelengths to increase imaging resolution.

29. The method of claim 28, wherein the light pulses of different wavelength include two or more of the following: red, blue, green, ultraviolet and infrared light.

30. The method of claim 28, wherein the combining combines the images of the scene illuminated by light pulses of the different wavelengths to form color images without filtering of the CCD or CMOS sensors.
